(19) United States
(12) Patent Application Publication
(10) Pub. No.: US 2014/0136441 A1
(43) Pub. Date: May 15, 2014

(54) METHODS AND SYSTEMS FOR IDENTITY BASED SUBSCRIPTION MANAGEMENT

(71) Applicant: Facebook, Inc., Menlo Park, CA (US)

(72) Inventors: Bikash Kumar Agarwalla, Fremont, CA (US); Prashant Fuloria, Los Altos, CA (US); Reshma Khilnani Ebberson, San Francisco, CA (US); Guy Rom, Los Altos, CA (US)

(21) Appl. No.: 13/677,062

(22) Filed: Nov. 14, 2012

(51) Int. Cl. G06Q 10/10

(52) U.S. Cl. CPC G06Q 10/107
USPC 705/344

(57) ABSTRACT

Techniques to allow a social networking system to facilitate management of relationships between service providers and users of the social networking system. In one embodiment, information regarding eligibility of a user to receive an offering of a service provider may be maintained. A request for the information regarding eligibility of the user from the service provider may be received. The information regarding eligibility of the user may be provided to the service provider. Provision of the information regarding eligibility of the user may be performed before at least a portion of the offering is provided by the service provider to the user.

### FIELD OF THE INVENTION

The present application relates to a social networking system and, in particular, management of subscriptions offered by service providers to users.

### BACKGROUND

Social networking websites provide a dynamic environment in which members can connect to and communicate with other members. These websites may commonly provide online mechanisms allowing members to interact within their preexisting social networks, as well as create new social networks. Members may include any individual or entity, such as an organization or business. Among other attributes, social networking websites allow members to effectively and efficiently communicate relevant information to their social networks.

A member of a social network may highlight or share personal information, news stories, relationship activities, music, and any other content of interest to areas of the website dedicated to the member. Other members of the social network may access the shared content by browsing member profiles or performing dedicated searches. Upon access to and consideration of the content, the other members may react by taking one or more responsive actions, such as providing an opinion about the content, or other feedback. The ability of members to interact in this manner fosters communications among them and helps to realize the goals of social networking websites.

Users of a social networking website may access additional websites. For example, the users may desire goods and services offered by merchants through other websites. As another example, the users may wish to access specialized content provided by other websites. In some circumstances, the users may access the other websites directly and, in other circumstances, the users may access the other websites indirectly through the social networking website. As to the latter, the other websites and their users desire efficient and convenient management of their relationships through the social networking website.

### SUMMARY

To allow a social networking system to facilitate management of relationships between service providers and users of the social networking system, embodiments of the invention include systems, methods, and computer readable media to maintain information regarding eligibility of a user to receive an offering of a service provider. A request for the information regarding eligibility of the user from the service provider may be received. The information regarding eligibility of the user may be provided to the service provider.

In an embodiment, provision of the information regarding eligibility of the user may be performed before at least a portion of the offering is provided to the user. In an embodiment, provision of the information regarding eligibility of the user may be performed periodically.

In an embodiment, a level of consumption by the user of the offering may be tracked. It may be determined that the level of consumption has satisfied a threshold. The user may be requested to upgrade an account with the service provider. A promotion may be provided to the user based on the level of consumption by the user. The promotion may include at least one of an email, a story, a badge, and a reference.

In an embodiment, information about selection by the user of the offering may be received.

In an embodiment, provision of the information regarding eligibility of the user is performed by a social networking system.

In an embodiment, the offering may include a subscription. In an embodiment, the offering may include charitable services. In an embodiment, the offering may be associated with services not provided to the user for consumption. In an embodiment, the service provider may provide at least one of music, content, and games.

In an embodiment, payment information of the user for the offering may be received. In an embodiment, payment information of the user for the offering may be maintained.

In an embodiment, a requested change regarding terms of a subscription acquired by the user may be received. In an embodiment, upgrade of an account with the service provider may be requested.

In an embodiment, a notification may be provided for the user to install an application of the service provider on a mobile computing device.

Many other features and embodiments of the invention will be apparent from the accompanying drawings and from the following detailed description.

### BRIEF DESCRIPTION OF THE DRAWINGS

FIG. 1 is a network diagram of a system for subscription management within a social networking system in accordance with an embodiment of the invention.

FIG. 2 illustrates a simplified block diagram of a system of interaction between the subscription management module of the social networking system in accordance with an embodiment of the invention.

FIG. 3 is an example process for exchanging information between the social networking system and a service provider in accordance with an embodiment of the invention.

FIG. 4 is an example process for promoting an offering of a service provider in accordance with an embodiment of the invention.

FIG. 5 illustrates an example screen that may be provided by the social networking system for a user to allow the user to purchase offerings from a service provider in accordance with an embodiment of the invention.

FIG. 6 illustrates an example screen that may be provided by the social networking system for a user to manage payment settings for offerings purchased by the user in accordance with an embodiment of the invention.

FIGS. 7A-7D illustrate example notices and functionality that may be provided by the social networking system for a user to upgrade an account with a service provider in accordance with embodiments of the invention.

FIGS. 8A-8E illustrate example notices and functionality that may be provided by the social networking system for a user to subscribe and install offerings of a service provider in accordance with embodiments of the invention.

FIG. 9 shows an example diagram of a computer system in accordance with an embodiment of the invention.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles of the invention described herein.

### DETAILED DESCRIPTION

### Social Networking System—General Introduction

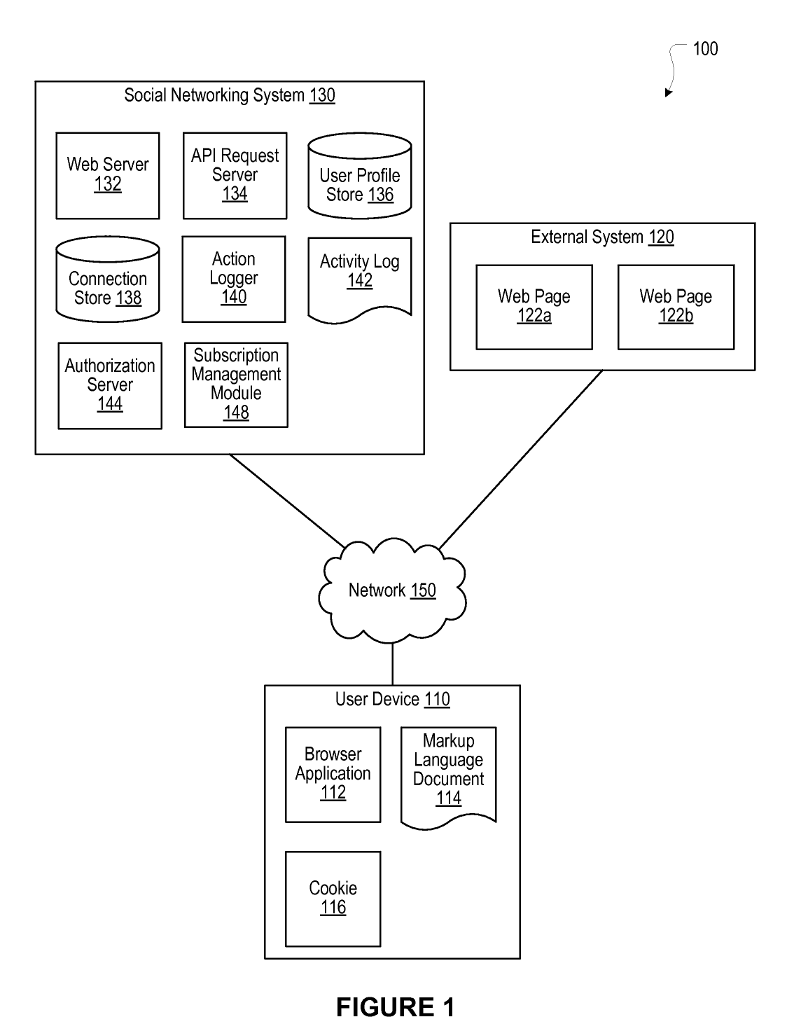

FIG. 1 is a network diagram of a system 100 for identity based subscription management in a social networking system 130 in accordance with an embodiment of the invention. The system 100 includes one or more user devices 110, one or more external systems 120, the social networking system 130, and a network 150. For purposes of illustration, the embodiment of the system 100, shown by FIG. 1, includes a single external system 120 and a single user device 110. However, in other embodiments, the system 100 may include more user devices 110 and/or more external systems 120. In certain embodiments, the social networking system 130 is operated by a social network provider, whereas the external systems 120 are separate from the social networking system 130 in that they may be operated by different entities. In various embodiments, however, the social networking system 130 and the external systems 120 operate in conjunction to provide social networking services to users (or members) of the social networking system 130. In this sense, the social networking system 130 provides a platform or backbone, which other systems, such as external systems 120, may use to provide social networking services and functionalities to users across the Internet.

The user device 110 comprises one or more computing devices that can receive input from a user and transmit and receive data via the network 150. In one embodiment, the user device 110 is a conventional computer system executing, for example, a Microsoft Windows compatible operating system (OS), Apple OS X, and/or a Linux distribution. In another embodiment, the user device 110 can be a device having computer functionality, such as a smart-phone, a tablet, a personal digital assistant (PDA), a mobile telephone, etc. The user device 110 is configured to communicate via the network 150. The user device 110 can execute an application, for example, a browser application that allows a user of the user device 110 to interact with the social networking system 130. In another embodiment, the user device 110 interacts with the social networking system 130 through an application programming interface (API) provided by the native operating system of the user device 110, such as iOS and ANDROID. The user device 110 is configured to communicate with the external system 120 and the social networking system 130 via the network 150, which may comprise any combination of local area and/or wide area networks, using wired and/or wireless communication systems.

In one embodiment, the network 150 uses standard communications technologies and protocols. Thus, the network 150 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 150 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 150 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 110 may display content from the external system 120 and/or from the social networking system 130 by processing a markup language document 114 received from the external system 120 and from the social networking system 130 using a browser application 112. The markup language document 114 identifies content and one or more instructions describing formatting or presentation of the content. By executing the instructions included in the markup language document 114, the browser application 112 displays the identified content using the format or presentation described by the markup language document 114. For example, the markup language document 114 includes instructions for generating and displaying a web page having multiple frames that include text and/or image data retrieved from the external system 120 and the social networking system 130. In various embodiments, the markup language document 114 comprises a data file including extensible markup language (XML) data, extensible hypertext markup language (XHTML) data, or other markup language data. Additionally, the markup language document 114 may include JavaScript Object Notation (JSON) data, JSON with padding (JSONP), and JavaScript data to facilitate data-interchange between the external system 120 and the user device 110. The browser application 112 on the user device 110 may use a JavaScript compiler to decode the markup language document 114.

The markup language document 114 may also include, or link to, applications or application frameworks such as FLASH™ or Unity™ applications, the SilverLight™ application framework, etc.

In one embodiment, the user device 110 also includes one or more cookies 116 including data indicating whether a user of the user device 110 is logged into the social networking system 130, which may enable customization of the data communicated from the social networking system 130 to the user device 110.

The external system 120 includes one or more web servers that include one or more web pages 122a, 122b, which are communicated to the user device 110 using the network 150. The external system 120 is separate from the social networking system 130. For example, the external system 120 is associated with a first domain, while the social networking system 130 is associated with a separate social networking domain. Web pages 122a, 122b, included in the external system 120, comprise markup language documents 114 identifying content and including instructions specifying formatting or presentation of the identified content.

The social networking system 130 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure.

Users may join the social networking system 130 and then add connections to any number of other users of the social networking system 130 to whom they desire to be connected. As used herein, the term “friend” refers to any other user of the social networking system 130 to whom a user has formed a connection, association, or relationship via the social networking system 130. For example, in an embodiment, if users in the social networking system 130 are represented as nodes in the social graph, the term “friend” can refer to an edge formed between and directly connecting two user nodes.

Connections may be added explicitly by a user or may be automatically created by the social networking system 130 based on common characteristics of the users (e.g., users who are alumni of the same educational institution). For example, a first user specifically selects a particular other user to be a friend. Connections in the social networking system 130 are usually in both directions, but need not be, so the terms “user” and “friend” depend on the frame of reference. Connections between users of the social networking system 130 are usually bilateral (“two-way”), or “mutual,” but connections may also be unilateral, or “one-way.” For example, if Bob and Joe are both users of the social networking system 130 and connected to each other, Bob and Joe are each other's connections. If, on the other hand, Bob wishes to connect to Joe to view data communicated to the social networking system 130 by Joe, but Joe does not wish to form a mutual connection, a unilateral connection may be established. The connection between users may be a direct connection; however, some embodiments of the social networking system 130 allow the connection to be indirect via one or more levels of connections or degrees of separation.

In addition to establishing and maintaining connections between users and allowing interactions between users, the social networking system 130 provides users with the ability to take actions on various types of items supported by the social networking system 130. These items may include groups or networks (i.e., social networks of people, entities, and concepts) to which users of the social networking system 130 may belong, events or calendar entries in which a user might be interested, computer-based applications that a user may use via the social networking system 130, transactions that allow users to buy or sell items via services provided by or through the social networking system 130, and interactions with advertisements that a user may perform on or off the social networking system 130. These are just a few examples of the items upon which a user may act on the social networking system 130, and many others are possible. A user may interact with anything that is capable of being represented in the social networking system 130 or in the external system 120, separate from the social networking system 130, or coupled to the social networking system 130 via the network 150.

The social networking system 130 is also capable of linking a variety of entities. For example, the social networking system 130 enables users to interact with each other as well as external systems 120 or other entities through an API, a web service, or other communication channels. The social networking system 130 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 130. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 130 modifies edges connecting the various nodes to reflect the relationships and interactions.

The social networking system 130 also includes user-generated content, which enhances a user's interactions with the social networking system 130. User-generated content may include anything a user can add, upload, send, or “post” to the social networking system 130. For example, a user communicates posts to the social networking system 130 from a user device 110. Posts may include data such as status updates or other textual data, location information, images such as photos, videos, links, music or other similar data and/or media. Content may also be added to the social networking system 130 by a third-party. Content “items” are represented as objects in the social networking system 130. In this way, users of the social networking system 130 are encouraged to communicate with each other by posting text and content items of various types of media through various communication channels. Such communication increases the interaction of users with each other and increases the frequency with which users interact with the social networking system 130.

The social networking system 130 includes a web server 132, an API request server 134, a user profile store 136, a connection store 138, an action logger 140, an activity log 142, an authorization server 144, and a subscription management module 148. In an embodiment of the invention, the social networking system 130 may include additional, fewer, or different components for various applications. Other components, such as network interfaces, security mechanisms, load balancers, failover servers, management and network operations consoles, and the like are not shown so as to not obscure the details of the system.

The user profile store 136 maintains information about user accounts, including biographic, demographic, and other types of descriptive information, such as work experience, educational history, hobbies or preferences, location, and the like that has been declared by users or inferred by the social networking system 130. This information is stored in the user profile store 136 such that each user is uniquely identified. The social networking system 130 also stores data describing one or more connections between different users in the connection store 138. The connection information may indicate users who have similar or common work experience, group memberships, hobbies, or educational history. Additionally, the social networking system 130 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 130, such as non-person entities, buckets, cluster centers, images, interests, pages, external systems, concepts, and the like are also stored in the connection store 138.

The social networking system 130 maintains data about objects with which a user may interact. To maintain this data, the user profile store 136 and the connection store 138 store instances of the corresponding type of objects maintained by the social networking system 130. Each object type has information fields that are suitable for storing information appropriate to the type of object. For example, the user profile store 136 contains data structures with fields suitable for describing a user's account and information related to a user's account. When a new object of a particular type is created, the social networking system 130 initializes a new data structure of the corresponding type, assigns a unique object identifier to it, and begins to add data to the object as needed. This might occur, for example, when a user becomes a user of the social networking system 130, the social networking system 130 generates a new instance of a user profile in the user profile store 136, assigns a unique identifier to the user account, and begins to populate the fields of the user account with information provided by the user.

The connection store 138 includes data structures suitable for describing a user's connections to other users, connections to external systems 120 or connections to other entities. The connection store 138 may also associate a connection type with a user's connections, which may be used in conjunction with the user's privacy setting to regulate access to information about the user. In an embodiment of the invention, the user profile store 136 and the connection store 138 may be implemented as a federated database.

Data stored in the connection store 138, the user profile store 136, and the activity log 142 enables the social networking system 130 to generate the social graph that uses nodes to identify various objects and edges connecting nodes to identify relationships between different objects. For example, if a first user establishes a connection with a second user in the social networking system 130, user accounts of the first user and the second user from the user profile store 136 may act as nodes in the social graph. The connection between the first user and the second user stored by the connection store 138 is an edge between the nodes associated with the first user and the second user. Continuing this example, the second user may then send the first user a message within the social networking system 130. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 130 (or, alternatively, in an image maintained by another system outside of the social networking system 130). The image may itself be represented as a node in the social networking system 130. This tagging action may create edges between the first user and the second user as well as create an edge between each of the users and the image, which is also a node in the social graph. In yet another example, if a user confirms attending an event, the user and the event are nodes obtained from the user profile store 136, where the attendance of the event is an edge between the nodes that may be retrieved from the activity log 142. By generating and maintaining the social graph, the social networking system 130 includes data describing many different types of objects and the interactions and connections among those objects, providing a rich source of socially relevant information.

The web server 132 links the social networking system 130 to one or more user devices 110 and/or one or more external systems 120 via the network 150. The web server 132 serves web pages, as well as other web-related content, such as Java, JavaScript, Flash, XML, and so forth. The web server 132 may include a mail server or other messaging functionality for receiving and routing messages between the social networking system 130 and one or more user devices 110. The messages can be instant messages, queued messages (e.g., email), text and SMS messages, or any other suitable messaging format.

The API request server 134 allows one or more external systems 120 and user devices 110 to call access information from the social networking system 130 by calling one or more API functions. The API request server 134 may also allow external systems 120 to send information to the social networking system 130 by calling APIs. The external system 120, in one embodiment, sends an API request to the social networking system 130 via the network 150, and the API request server 134 receives the API request. The API request server 134 processes the request by calling an API associated with the API request to generate an appropriate response, which the API request server 134 communicates to the external system 120 via the network 150. For example, responsive to an API request, the API request server 134 collects data associated with a user, such as the user's connections that have logged into the external system 120, and communicates the collected data to the external system 120. In another embodiment, the user device 110 communicates with the social networking system 130 via APIs in the same manner as external systems 120.

The action logger 140 is capable of receiving communications from the web server 132 about user actions on and/or off the social networking system 130. The action logger 140 populates the activity log 142 with information about user actions, enabling the social networking system 130 to discover various actions taken by its users within the social networking system 130 and outside of the social networking system 130. Any action that a particular user takes with respect to another node on the social networking system 130 may be associated with each user's account, through information maintained in the activity log 142 or in a similar database or other data repository. Examples of actions taken by a user within the social networking system 130 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 130, the action is recorded in the activity log 142. In one embodiment, the social networking system 130 maintains the activity log 142 as a database of entries. When an action is taken within the social networking system 130, an entry for the action is added to the activity log 142. The activity log 142 may be referred to as an action log.

Additionally, user actions may be associated with concepts and actions that occur within an entity outside of the social networking system 130, such as an external system 120 that is separate from the social networking system 130. For example, the action logger 140 may receive data describing a user's interaction with an external system 120 from the web server 132. In this example, the external system 120 reports a user's interaction according to structured actions and objects in the social graph.

Other examples of actions where a user interacts with an external system 120 include a user expressing an interest in an external system 120 or another entity, a user posting a comment to the social networking system 130 that discusses an external system 120 or a web page 122a within the external system 120, a user posting to the social networking system 130 a Uniform Resource Locator (URL) or other identifier associated with an external system 120, a user attending an event associated with an external system 120, or any other action by a user that is related to an external system 120. Thus, the activity log 142 may include actions describing interactions between a user of the social networking system 130 and an external system 120 that is separate from the social networking system 130.

The authorization server 144 enforces one or more privacy settings of the users of the social networking system 130. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 120, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 120. One embodiment allows the specification of the set of entities to comprise an enumeration of entities. For example, the user may provide a list of external systems 120 that are allowed to access certain information. Another embodiment allows the specification to comprise a set of entities along with exceptions that are not allowed to access the information. For example, a user may allow all external systems 120 to access the user's work information, but specify a list of external systems 120 that are not allowed to access the work information. Certain embodiments call the list of exceptions that are not allowed to access certain information a “block list”. External systems 120 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 144 contains logic to determine if certain information associated with a user can be accessed by a user's friends, external systems 120, and/or other applications and entities. The external system 120 may need authorization from the authorization server 144 to access the user's more private and sensitive information, such as the user's work phone number. Based on the user's privacy settings, the authorization server 144 determines if another user, the external system 120, an application, or another entity is allowed to access information associated with the user, including information about actions taken by the user.

The subscription management module 148 contains logic to allow users of the social networking system 130 to subscribe to a multitude of external systems 120. The subscription management module 148 manages subscriptions of users to offerings provided through websites of the external systems 120. The offerings may include goods, services, and content that may not be provided by the social networking system 130. As set forth below, the subscription management module 148 and the social networking system 130 allow users to control their access to and use of the external systems 120. Further, the subscription management module 148 also provides information to the external systems 120 to allow them to manage access to their offerings, as described in more detail below.

### Subscription Management

The social networking system 130 may serve as a platform to present its users with access to a variety of websites and their offerings. The social networking system 130 may provide its own offerings to its users. In addition, service providers, represented as the external systems 120 distinct from the social networking system 130, may provide their offerings through the social networking system 130. As used herein, “service providers” refer to any entities that provide services, goods, content, or other tangible or intangible offerings.

A user of the social networking system 130 may desire access to a wide array of offerings provided by a multitude of service providers. For example, users of the social networking system 130 may subscribe to myriad service providers to access different types of information and content, such as music, news, entertainment, traffic reports, job listings, weather reports, and the like. As a related example, users, through the capabilities of the social networking system 130, may subscribe to various types of professional services, such as health services, financial services, attorney services, etc. As another example, users also may play games, participate in gambling activities, and otherwise enjoy other types of entertainment provided by different service providers through the social networking system 130. As yet another example, from the social networking system 130, users may download applications of service providers to a computing device and use the applications to access offerings of the service providers. As yet still another example, users may order products and other tangible goods (e.g., magazines, durable consumer goods, nondurable consumer goods, etc.) from merchants through the social networking system 130. A wide variety of offerings in addition to those expressly described may be accessed by users through the social networking system 130.

Using the social networking system 130, a user is not limited to seeking offerings of service providers to benefit herself only. Rather, a user also may use the social networking system 130 to cause service providers to supply services to others, whether known or unknown to the user. For example, a user, through contributions provided through the social networking system 130, may request that an organization provide services to certain individuals or other beneficiaries. The organization could be a charitable or other type of organization that provides services to others. As another example, a user, through the social networking system 130, may provide donations to service providers, such as non-profit entities, to promote various medical, social, religious, political, or other types of causes.

A user may use the social networking system 130 to access various service providers and their offerings. Because interactions of the user with a multitude of service providers can be cumbersome and complex, the social networking system 130 may act as a platform, or focal point, to facilitate and organize such interactions. The social networking system 130 may provide a unified system of control to conveniently and seamlessly manage the relationships between the user and countless other service providers. Based on its unique role as a platform, the social networking system 130 may act as a “source of truth” for service providers in the determination of user eligibility to access and consume their offerings. Before a service provider provides access to its offerings to a user, the service provider may query the social networking system 130 to assess whether the user is eligible for such access. The user may employ a desktop version or a mobile version of the user device 110 to access offerings of various service providers through the social networking system 130.

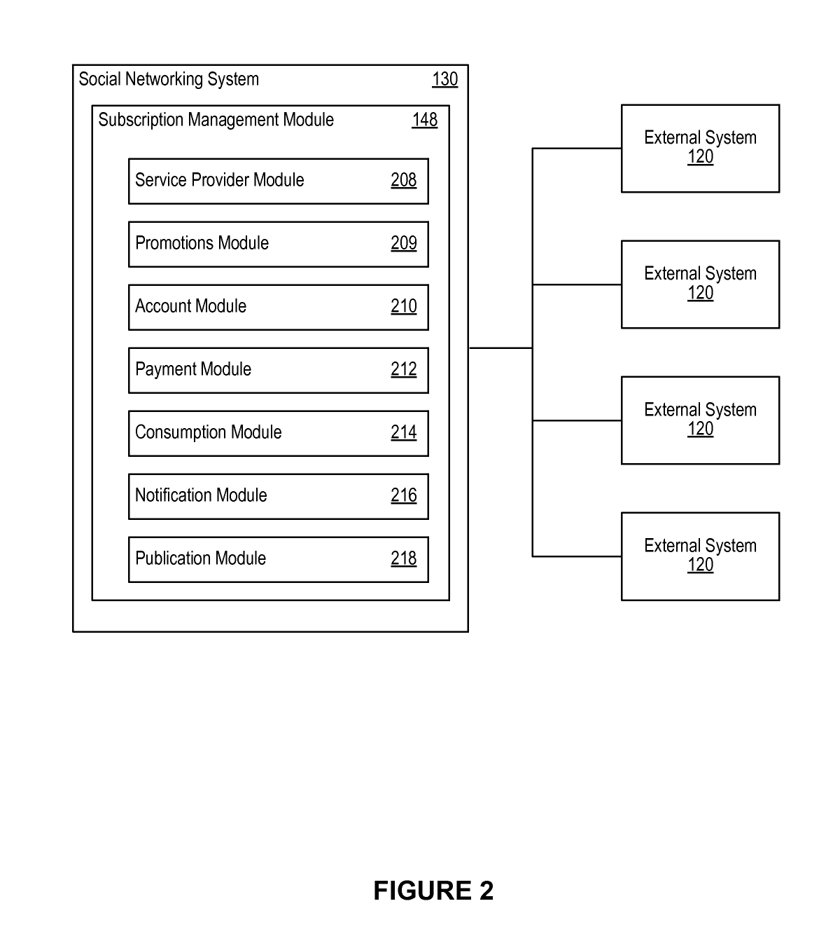

FIG. 2 illustrates a simplified block diagram of a system of interaction between the subscription management module 148 of the social networking system 130 and a multitude of service providers, each represented as one of the external systems 120, in accordance with an embodiment of the invention. As shown, the social networking system 130 may interact with any number of service providers to serve as a central resource to provide a potentially limitless number of offerings to users of the social networking system 130. The subscription management module 148 of the social networking system 130 contains logic to provide management and control of the relationships between the user and various service providers. The subscription management module 148 may include a service provider module 208, a promotions module 209, an account module 210, a payment module 212, a consumption module 214, a notification module 216, and a publication module 218. The modules of the subscription management module 148 are exemplary, and may be variously combined into fewer modules or separated into additional modules. The service providers may communicate, through APIs or other communication interfaces, with the social networking system 130 and exchange information with the social networking system 130 about access to or use of offerings provided by the service providers.

The notification module 216 interacts with the service provider module 208, the promotions module 209, the account module 210, the payment module 212, the consumption module 214, and the publication module 218. The notification module 216 manages and provides notifications to the user to inform the user about information relevant to user accounts with service providers, as discussed herein. For example, the notification module 216 may create notices for the user about the consumption level of the user reaching a certain threshold, the availability of remaining levels of consumption, additional service providers and offerings in which the user may be interested, or any other type of information that may reflect or enhance the experience of the user in accessing the offerings of service providers through the social networking system 130. Further, the notification module 216 may provide notices to friends of the user or others regarding access to or consumption of offerings by the user to encourage the them to likewise consider the offerings.

The service provider module 208 may manage and provide an identification of service providers from which the user may select desired offerings. The identification may be an exhaustive listing of all possible service providers accessible from the social networking system 130, an optimized listing of service providers that have been identified by the social networking system 130 to be of special interest to the user based on attributes of or other considerations associated with the user, or any other type of indication of available service providers.

The service provider module 208 may manage and provide information about the identity and profile of a service provider, as well as information about its offerings. Such information about offerings of a service provider may include a listing of the different services or goods that may be offered by the service provider through the social networking system 130, and related payment information including pricing information. Further, information about the offerings of a service provider may include specifications regarding availability of the offerings on different platforms. For example, such information may provide whether a particular offering can be provided to a desktop computing device, a mobile computing device, or both. As another example, such information may provide whether delivery of the offering requires or prefers certain conditions, such as a selected communication bandwidth or other type of delivery medium. The service provider also may distinguish each offering based on its associated platform, delivery method, or other type of specification.

Payment information may include pricing information, such as normal, discount, and special promotion pricing, and times during which certain pricing is effective or unavailable. Payment information also may include payment forms and methods acceptable to the service provider, such as credit card, debit cards, online payment processors, etc. Payment information also may include payment schedule information concerning due dates for payments required at regular or selected intervals, such as monthly dues for a fixed or indefinite subscription to the offering of a service provider.

The promotions module 209 may manage and provide promotional information regarding offerings of service providers. Service providers may provide promotional information, including promotional criteria, and provide that criteria to the social networking system 130 so that advertisements are selectively displayed to a user. For example, the promotions module 209 may execute a request of a service provider that the social networking system 130 display an advertisement for a particular offering for a user when a predetermined event occurs. As an example, the predetermined event may include the occurrence of a threshold number of friends of the user that have already used the offering. As another example, the promotions module 209 may execute a request of a service provider that the social networking system 130 display an advertisement for an offering to a user when the user has “liked” content that is associated with the offering. As yet another example, the promotions module 209 may provide an advertisement to a user about an offering that indicates that friends of the user have purchased or otherwise consumed the offering.

The promotions module 209 may provide to the user a selection of different offerings and offering (service) levels offered by the service providers. As an example, the service provider may be a streaming music website. The streaming music website may provide different offerings, such as a variety of individual songs in different music genres from different periods of time and in different languages. Further, the streaming music website may provide various levels of service to access its music offerings, such as free services, a one-time service, basic services, premium services, monthly services, annual services, etc. As another example, the service provider may be a gaming website. The gaming website may provide different offerings in the form of various game titles. The gaming website may further provide different levels of service, such as a default service for ordinary users and an elite service for frequent users of the gaming website.

The payment module 212 of the subscription management module 148 may provide to the user a capability to fund an account with the social networking system 130 to pay service providers for desired offerings. Payment credentials, such as information relating to a credit card, debit card, or other payment processing vehicle, may be provided by users and maintained within the social networking system 130. The user may provide the payment credentials maintained by the social networking system 130 to pay for selected offerings of service providers at desired levels of service. When the user has requested a desired offering of a service provider, the social networking system 130 may trigger a process to retrieve the maintained payment credentials associated with the user and present the payment credentials to the service provider as payment for the desired offering. In an embodiment, the social networking system 130 or the service provider, or both, may perform payment processing for transactions involving the desired offering.

The account module 210 of the subscription management module 148 may allow the user to manage the nature of her relationships with various service providers. If a user is subscribed to a service provider, the account module 210 may create an account for the user associated with the service provider. The account module 210 may allow the user to take various actions to manage the account with the service provider. For example, a user account or subscription with the service provider may be created, upgraded, downgraded, edited, or canceled. As another example, the account module 210 may maintain information about the operational context in which the user accesses the social networking system 130 and the offerings of the service provider. The operational context information may include the types of devices (e.g., desktop computer, smart phone, tablet, etc.) employed by the user and the overall communication environment (e.g., bandwidth, language, time zone, etc.). The operational context information may reflect real-time, historical, or preferred access conditions. By accounting for operational context information, the service provider may optimize the delivery of offerings to or otherwise improve interactions with the user.

The account module 210 may facilitate management of user access to the service providers. For example, the account module 210 may prompt the user to provide permission for the social networking system 130 to automatically access the external system 120 of a service provider without the need for the user to separately log in to the external system 120. After permission is provided, the user and the social networking system 130, upon logging into the social networking system 130, may automatically access the external system 120. As another example, upon receipt of permission by the user, the account module 210 may provide login credentials and profile information of the user (e.g., username, password) for the social networking system 130 to the service provider. When the service provider requires access to the account of the user on the social networking system 130, the service provider may present the credentials back to the social networking system 130 to enjoy access to information about the user and her account.

The account module 210 may maintain information about the particular offerings of service providers for which the user is eligible. Because the social networking system 130 acts as a platform on which each user may purchase or otherwise become eligible to receive the offerings of the service providers, the social networking system 130 may continuously track the eligibility of each user to receive the offerings of different service providers. For example, a user, through the social networking system 130, may purchase a certain amount of music from a service provider that streams music. The account module 210 may record that the user has purchased the amount of music from the service provider and that the user is now entitled to that amount of music. If the user purchases a subscription to an online content provider through the social networking system 130, the account module 210 also may record the purchase of the subscription by the user as well as details about the terms of the purchased subscription. Further, the account module 210 may provide a record about the level of consumption of an offering by the user, as determined by the consumption module 214.

The consumption module 214 may track the levels of consumption by the user. The offerings of the service providers may be delivered to the user through the social networking system 130. As a result, the social networking system 130 may track, in real time or otherwise, the delivery and usage of offerings of service providers to users. For example, if, using the social networking system 130, a user has purchased an item of content from a service provider, the social networking system 130 may record the provision of the item to the user. As another example, if, using the social networking system 130, the user listens to music from a service provider that streams music, the social networking system 130 may track the amount of music to which the user has listened.

The consumption module 214 may determine the amount or level of consumption of an offering by the user and compare the consumed level with other levels. The other levels may include the level originally purchased by the user, a selected percentage of the level originally purchased by the user, the level used by friends of the user, etc. For example, the social networking system 130 may determine that a user has played 314 minutes of a certain online game provided by a service provider to the user through the social networking system 130. The social networking system 130 may retrieve a record about the level of time that the user originally purchased from the service provider and compare that level of time with level of the time actually played by the user. For example, the user may have initially purchased 360 minutes of time from the service provider. As a result, the social networking system 130 may determine that the user is left with only 46 minutes of playing time.

Responsive action may be taken by the social networking system 130 based on the determination of the levels of consumption of a user. If the level of consumption has reached a threshold relating to an absolute amount or a relative amount, the social networking system 130 may provide a notice to the user about the level of consumption and may encourage the user to consider an additional purchase. In an embodiment, the satisfaction of a threshold level of consumption by a user also may prompt the social networking system 130 to provide a notice to a friend of the user about satisfaction of the threshold and to propose to the friend that she consider an additional purchase of the offering. Examples of such notices include but are not limited to a dialog box, a pop up window, and an email. Proposal of an additional purchase to the user or her friend may involve the same offering or a different offering.

Responsive action may be taken by a service provider based on the determination of the levels of consumption of an offering by a user. A service provider may query the social networking system 130 about the level of consumption of its offering by the user, or the social networking system 130 may periodically communicate to the service provider the level of consumption. By receiving information from the social networking system 130 regarding the level of consumption, the service provider may take appropriate action. For example, if the user has consumed a threshold percentage of a purchased offering (e.g., an amount of time to listen to music), the service provider may provide a real time, or near real time, notice to the user about the level of consumption of the user and ask the user if she would like to make an additional purchase (e.g., additional time to listen to music). As another example, if the user has consumed the entirety of an offering, the service provider may refuse to provide additional offerings (e.g., cease provision of music altogether). Before providing offerings to the user upon request of the user, the service provider may receive information from the social networking system 130 about the eligibility of the user to receive more offerings and confirm that the level of consumption of the user warrants such provision. Otherwise, the service provider may refuse to provide its offerings to the user. The service provider over time may make multiple requests for information about the eligibility of the user to receive an offering because the eligibility status of the user over time may change.

The publication module 218 manages and provides information about access to and consumption of offerings by users. When a user is eligible to consume an offering of a service provider or when the level of consumption of the user has reached a threshold, the publication module 218 may publish such eligibility or other consumption information related to the offerings of the user to the social network of the user. The consumption information may be published on pages of the social networking system 130 that contain content tailored for and by the user and her network of friends. For example, consumption information may include an indication that the user has purchased or consumed an offering and may be provided in an entry on a timeline of events and activities about the user. In an embodiment, a badge or other reference may be published on the timeline, indicating that the user has access to or consumed an offering of a service provider. The badge may serve as a visible indication to friends of the user of the user's support of or satisfaction with the offering of a service provider, thus encouraging the friends to take interest in the offering. As another example, the consumption information may be published in the news feeds of friends of the user. When the user has purchased an offering or consumed an offering, news of the event may be published in the news feeds of friends of the user to disseminate information about the purchase or consumption and to promote the offering among the friends of the user. Consumption information relating to the user may be posted to other portions of the social networking system 130 to promote offerings to others both within and outside the social network of the user.

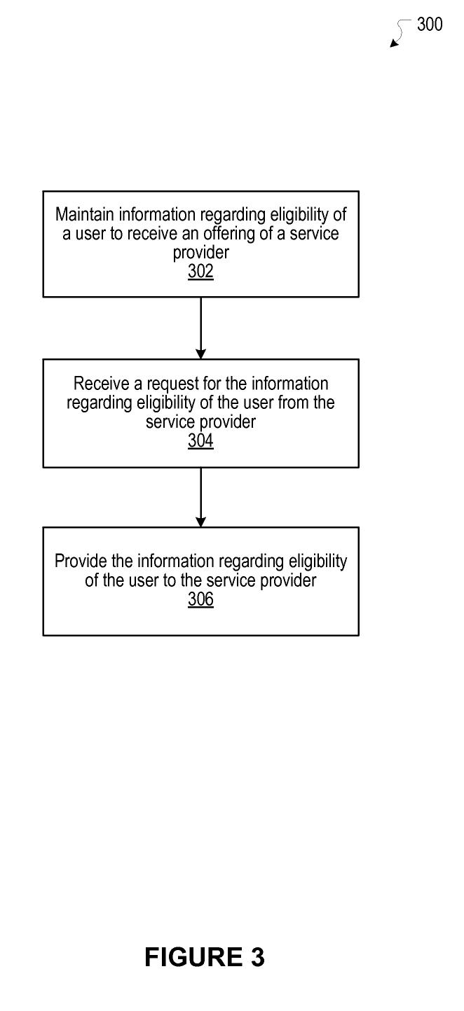

FIG. 3 is an example process for exchanging information between the social networking system 130 and a service provider in accordance with an embodiment of the invention. At block 302, information regarding eligibility of a user to receive an offering of a service provider is maintained. The eligibility of the user to receive an offering of a service provider may be based on a purchase by the user of the offering. In an embodiment, the eligibility of the user may not be based on a purchase. For example, the eligibility of the user may be based on a free trial offer, a conversion performed by the user with respect to certain promotional information of the service provider, a gift to the user from another, or any other activity that would entitle the user to access or consume the offering. Information about the eligibility of the user to receive an offering of a service provider may be maintained in the user profile store 136 or any other repository of the social networking system 130.

At block 304, a request for the information regarding eligibility of the user from the service provider is received. The service provider may provide the request to the social networking system 130 to determine whether the user is entitled to receive an offering of the service provider before initial or continued access to the offering is provided to the user. Further, the service provider may request from the social networking system 130 the operational context information, as discussed above. Because the social networking system 130 tracks the eligibility of the user to receive offerings as well as the usage of the offerings by the user, the social networking system 130 may serve as a resource for the service provider to manage the provision of offerings.

At block 306, the information regarding eligibility of the user to is provided to the service provider. The information regarding eligibility of the user may be provided to the service provider in different manners. For example, the information regarding eligibility of the user may be periodically provided by the social networking system 130 at selected intervals (e.g., hourly, daily, weekly, annually, etc.) or at intermittent times. The information may be automatically provided to the service provider, responsively provided to the service provider based on requests by the service provider for such information, or both. Based on the information regarding the eligibility of the user, the service provider may choose to accept or reject a request by the user to access an offering. If the social networking system 130 provides to the service provider information that the user is ineligible, the service provider may reject a request by the user to access offerings. If the social networking system 130 provides to the service provider information that the user is eligible, the service provider may accept the request by the user to access offerings. Further, the operational context information may be provided to the service provider to allow the service provider to adjust or tailor the offerings for the user, as discussed above.

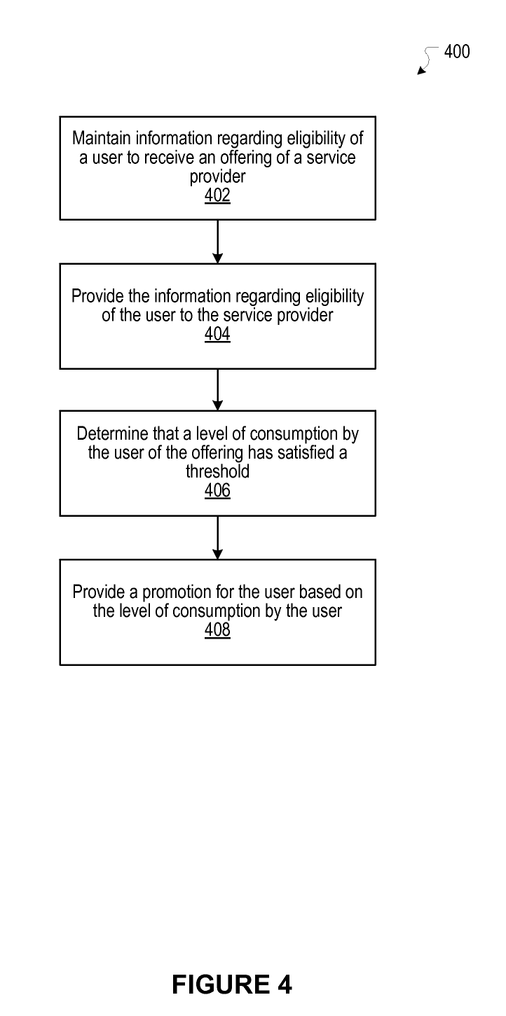

FIG. 4 is an example process 400 for promoting an offering of a service provider in accordance with an embodiment of the invention. At block 402, information regarding eligibility of a user to receive an offering of a service provider is maintained. The eligibility of the user to receive an offering of a service provider may be based on a purchase by the user of the offering. In an embodiment, the eligibility of the user may not be based on a purchase. For example, the eligibility of the user may be based on a free trial offer, a conversion performed by the user with respect to certain promotional information of the service provider, a gift to the user from another, or any other activity or demographic feature that may entitle the user to consume the offering according to the preferences of a service provider. Information about the eligibility of the user to receive an offering of a service provider may be maintained in the user profile store 136 or any other repository of the social networking system 130.

At block 404, the information regarding eligibility of the user is provided to the service provider. The information regarding eligibility of the user may be provided to the service provider in different manners before the service provider determines whether to provide to the user initial or continued access to an offering. For example, the information regarding eligibility of the user may be periodically provided by the social networking system 130 at selected intervals (e.g., hourly, daily, weekly, annually, etc.), at intermittent times, or even continuously. The information may be automatically provided to the service provider, responsively provided to the service provider based on requests by the service provider for such information, or both. Based on the information regarding the eligibility of the user, the service provider may choose to accept or reject a request by the user to access an offering. If the social networking system 130 provides to the service provider information that the user is ineligible, the service provider may reject a request by the user to access offerings. If the social networking system 130 provides to the service provider information that the user is eligible, the service provider may accept the request by the user to access offerings.

At block 406, it is determined that a level of consumption by the user of the offering has satisfied a threshold. The determination may be based on tracking the level of consumption of the user. The tracked level of consumption may be compared with a preselected parameter. For example, tracking the level of consumption of the user may indicate that, at a certain time, the level of consumption by the user has satisfied or exceeded a preselected portion of an entire amount to which the user is entitled. The preselected parameter may be determined by the social networking system 130 or a service provider, or both.

At block 408, a promotion is provided to the user based on the level of consumption by the user. The promotion may be of any variety. For example, the promotion may include an invitation to purchase additional amounts of the offering, to purchase new offerings, to upgrade an offering level, etc. In an embodiment, the promotion may be provided to someone other than the user to promote the service provider or its offering. For example, the promotion may be provided to friends of the user who may be interested in the level of consumption of the offering by the user and may be interested in likewise accessing the offering. In an embodiment, the process 300 and the process 400 may be performed in whole or in part by the subscription management module 148 or the social networking system 130.

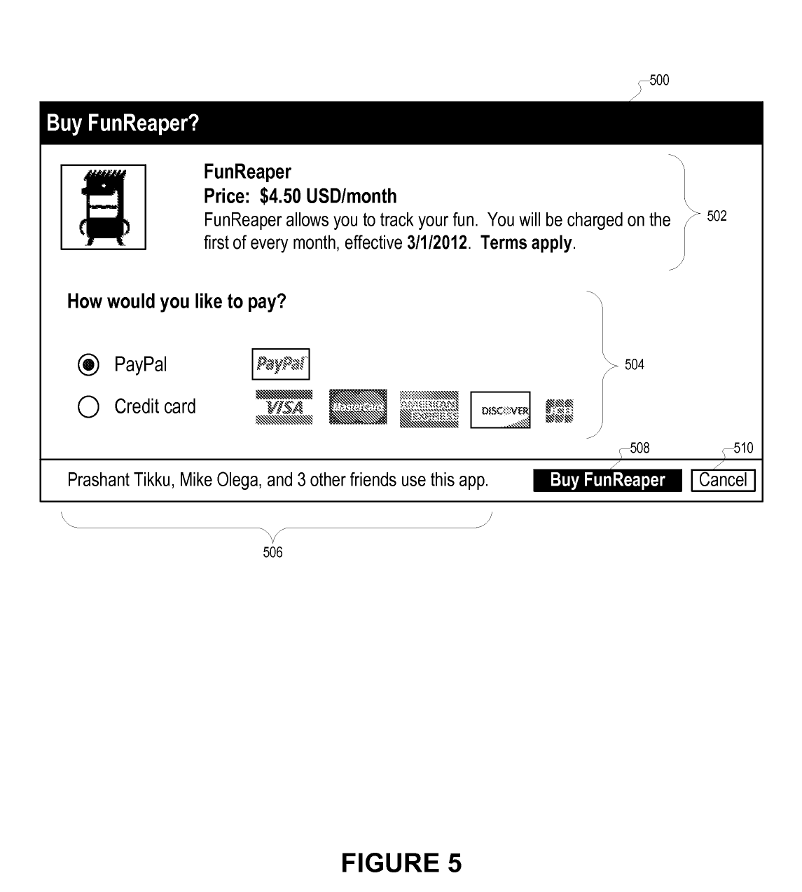

FIG. 5 illustrates example screen 500 that may be provided by the social networking system 130 for a user to allow the user to purchase offerings from a service provider in accordance with an embodiment of the invention. As shown, the offering is a subscription to an application provided by the service provider. Any other type of offering is possible. The screen 500 includes a terms field 502, a payment field 504, a social network information field 506, a “buy” button 508, and a “cancel” button 510. The terms field 502 includes terms related to the potential purchase, including the name of the offering, the price of the offering, a description of the offering, payment terms, and a link to other payment terms applicable to a purchase transaction. The payment field 504 allows the user to select a payment method for the desired offering. Payment methods may include a variety of payment processors and credit cards associated with the user. The social network information field 506 informs the user about other friends in her social network that have already purchased or consumed the offering referenced in the screen 500. As shown, the social network information field 506 indicates that a total of five friends of the user have already used the application. Based on selection of a payment method provided by the payment field 504 and the “buy” button 508, the social networking system 130 may trigger a process to retrieve the maintained payment credentials associated with the user and present the payment credentials to the service provider as payment for the desired offering. The “cancel” button 510 allows the user to remove the screen 500 from display and cease purchase consideration.

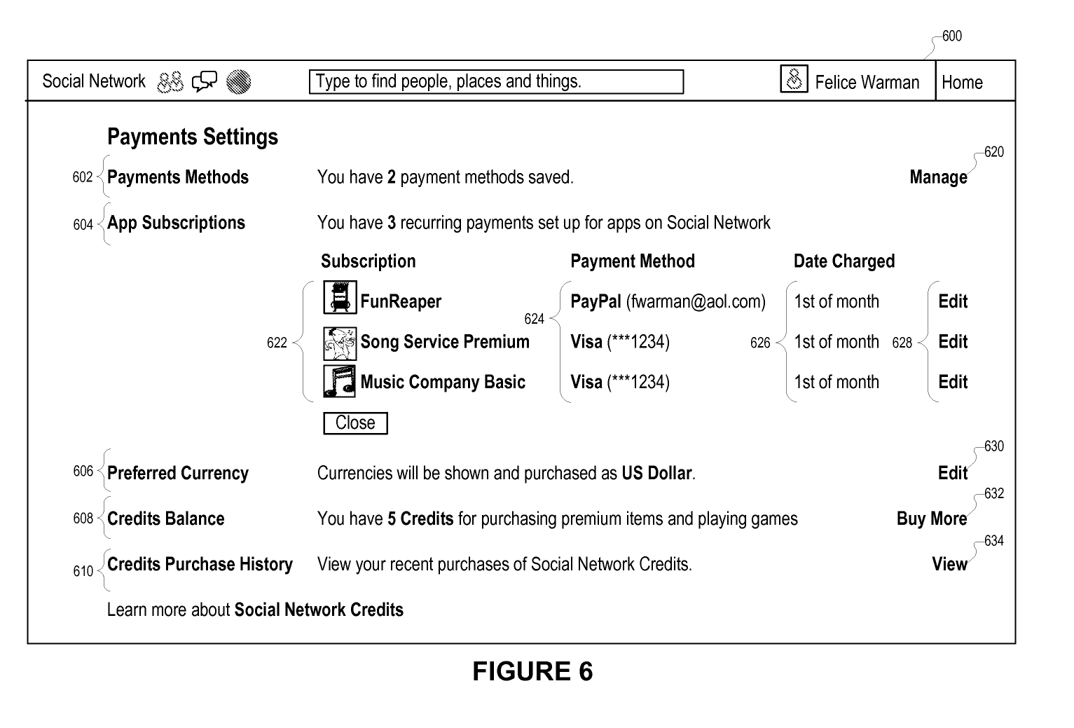

FIG. 6 illustrates an example screen 600 that may be provided by the social networking system 130 for a user to manage payment settings for offerings purchased by the user in accordance with an embodiment of the invention. The screen 600 includes a payment method section 602, a subscriptions section 604, a preferred currency section 606, a credits balance section 608, and a credits purchase history section 610. The payment method section 602 may allow the user to manage the payment methods provided by the user to pay for offerings of service providers. Selection of a “manage” link 620 may allow the user to add, subtract, or edit payment methods and related information. Payment method information may include payment credentials for a credit card, debit card, or other payment processing vehicle.

The subscriptions section 604 may provide information about offerings of the user and related payment information. An offering listing section 622 identifies the offerings that the user is eligible to receive. As shown, the offerings may include subscriptions to service providers. Other types of offerings may be identified in the offering listing section 622. A payment method section 624 identifies the payment method associated with each offering and may include an account identifier associated with a payment method, such as an email address or account number. A charge date section 626 indicates when the payment method is charged for the offerings of the user. For example, the charge date for a first offering of the user may be the first day of the month, the charge date for a second offering of the user may be the 15^{th} day of the month, and the charge date for a third offering of the user may be the last day of the year. “Edit” links 628 may be provided for the listed offerings in the subscriptions section 604. The “edit” links 628, when selected, may allow the user to modify the information of the subscription section 604.

The preferred currency section 606 may indicate the type of currency used to purchase the offerings. An “edit” link 630 may allow the user to modify the currency used to purchase the offerings. The credits balance section 608 may indicate the credits of the user for offerings of service providers. For example, credits may be accumulated by the user for purchasing premium offerings of service providers or playing certain games offered by service providers. A “buy more” link 632 may allow the user to purchase or otherwise acquire more credits to be used for acquisition of additional offerings. The credits purchase history section 610 may allow the user to access historical information about the credits that have been acquired by the user. A “view” link 634, when selected, may provide a history of credit acquisitions.

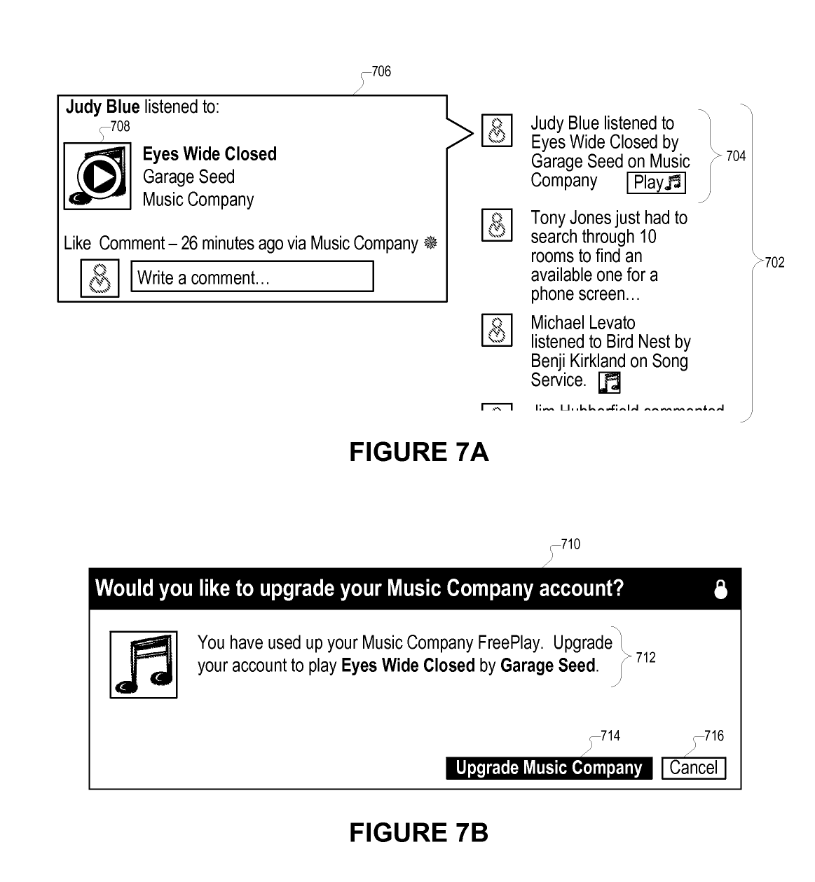

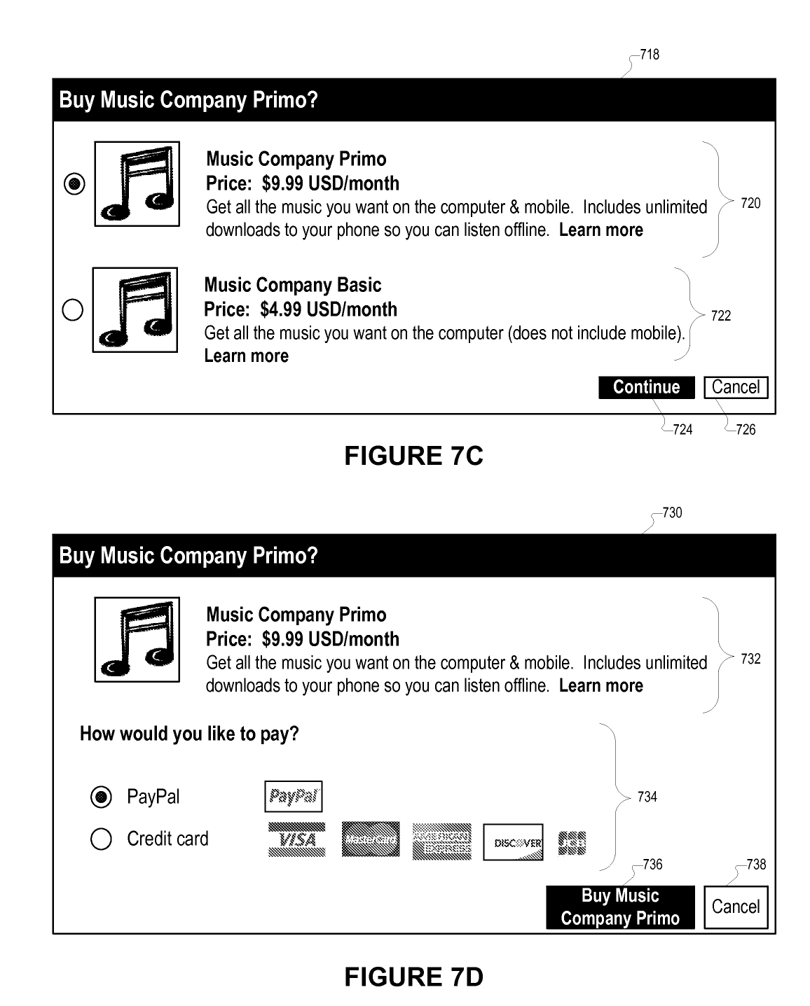

FIGS. 7A-7D illustrate example notices and functionality that may be provided by the social networking system 130 for a user to upgrade an account with a service provider in accordance with embodiments of the invention. FIG. 7A includes a ticker 702 presented by the social networking system 130 for a user that may include references to various activities or events relating to the social network of the user. The references may appear in the ticker 702 in real time or in delayed time as the activities and events take place. As shown, the ticker 702 includes a reference 704 indicating that a friend of the user is consuming an offering of a service provider. The reference 704 may serve as promotion of the offering, and encourage the user to likewise consume the offering. Upon selection of the reference 704, the user is presented with a dialog box 706 that provides more information about the activity described in the reference 704. The dialog box 706 may provide a detailed description of the offering consumed by the friend, the service provider that provided the offering to the friend, and an ability of the user to “like” or comment on the activity. The dialog box 706 may also provide a link 708 to the offering (e.g., a play button) so that the user herself may access the offering.

FIG. 7B illustrates an example notice 710 that may be presented by the social networking system 130 for the user upon selection of the link 708 when the user is not initially eligible to access the offering. The notice 710 may be a promotional message to the user reflecting eligibility of the user to access offerings from the service provider and an invitation to upgrade her eligibility. As shown, the notice 710 indicates that the user is no longer eligible for offerings of the service provider. A message section 712 may include a description of the eligibility of the user to access the offering. If the user is not eligible to access the offering, the message section 712 may ask the user if she would like to become eligible to access the offering by, for example, upgrading her account. An “upgrade” button 714, when selected, sends a request to the social networking system 130 to allow the user to upgrade her account with the service provider. A “cancel” button 716, when selected, sends an indication to the social networking system 130 that the user does not wish to upgrade to access the offering.

FIG. 7C illustrates an example notice 718 that may be presented by the social networking system 130 for the user upon selection of the “upgrade” button 714. The notice 718 may identify options for different levels of offerings provided by the service provider for selection by the user. Different levels of offerings may include different qualities of offerings, different volumes of offerings, or any other possible distinctions in the offerings provided by a service provider. The options may reflect pricing and related payment information for each level of offering. As shown, the notice 718 may describe various levels of subscription to the services of the service provider. A subscription option 720, when selected, may provide the user access to a larger amount of services for a higher price, while an option 722, when selected, may provide the user access to a smaller amount of services for a lower price. After selection of an option, a user may select a “continue” button 724 to proceed in the process to upgrade her access to the offerings of the service provider. Alternatively, a “cancel” button 726 may be selected by the user to terminate her initial interest in upgrading access.

FIG. 7D illustrates an example notice 730 that may be presented by the social networking system 130 for the user upon selection of the “continue” button 724. The notice 730 may include a subscription description 732 that provides information about the features and terms (e.g., price, offering levels, cancellation, refunds, etc.) of the subscription for which the user has opted. A payment method section 734 presents the payment methods associated with the user, and prompts the user to select the particular payment method for the particular offering. A “buy” button 736, when selected, causes a request to be provided to the social networking system 130 to proceed with purchase of the offering. A “cancel” button 738, when selected, allows the user to terminate purchase of the offering.

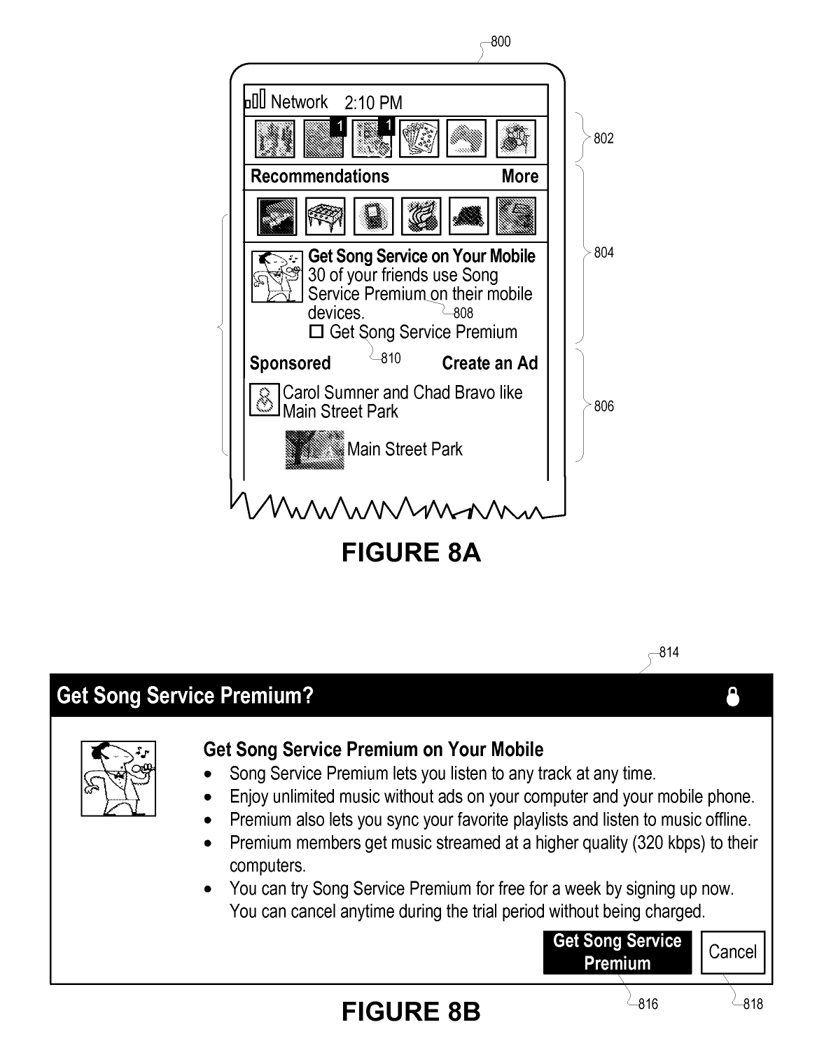

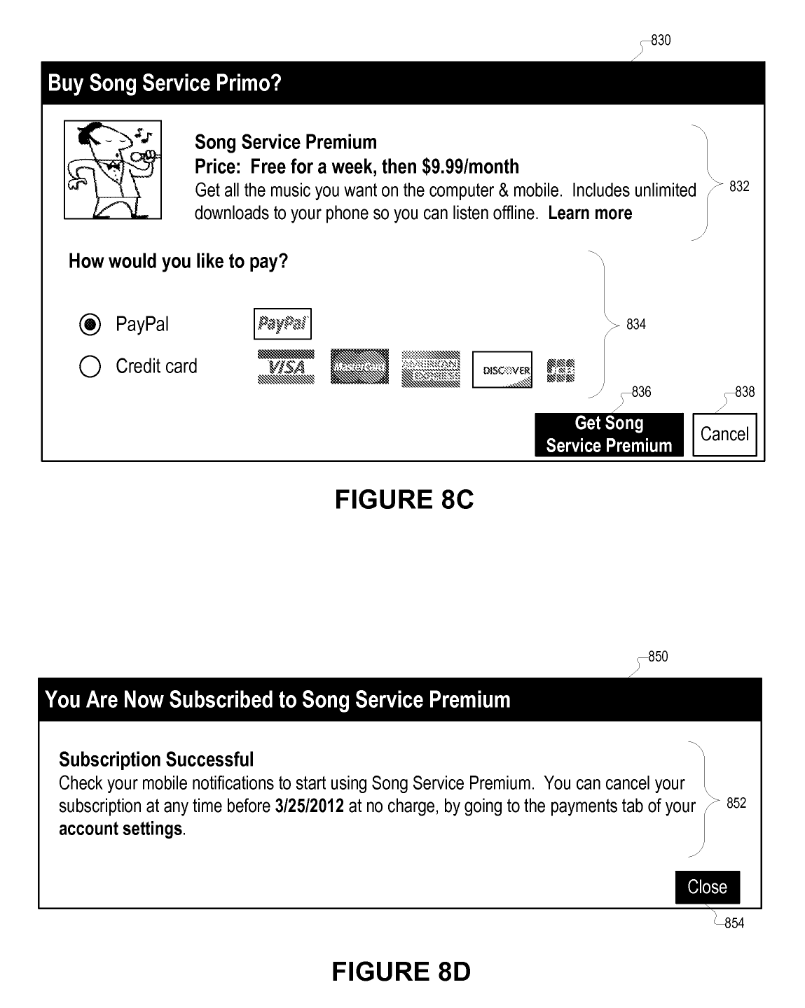

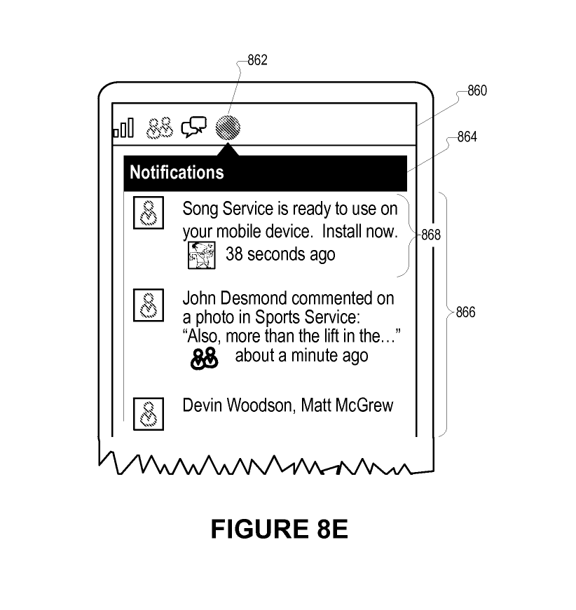

FIGS. 8A-8E illustrate example notices and functionality that may be provided by the social networking system 130 for a user to subscribe to and install offerings of a service provider in accordance with embodiments of the invention. FIG. 8A illustrates an example partial user interface 800 of a user device that may be provided by the social networking system 130 for a user. In an embodiment, the user device may be a mobile device or a non-mobile device. The user interface 800 includes a favorites section 802, a recommendations section 804, and a sponsored stories section 806. The favorites section 802 may include links to service providers and websites that may be favored by the user. The recommendations section 804 may include references or links to offerings that are presented to the user as recommendations. The recommendations section 804 also may include references to service providers that are recommended to the user. A service provider may be presented to the user as a recommendation in various circumstances. For example, the social networking system 130 may determine that a predetermined number of friends of the user have accessed offerings of the service provider and accordingly present a recommendation to the user to likewise access the offerings of the service provider. As another example, the social networking system 130 may provide the recommendation for the user to access the offerings of the service provider based on the profile or the activities of the user herself, or any other consideration. As shown, when a service provider is recommended to a user, the recommendations section 804 may provide social network information 808 to the user that her friends have consumed the offerings of the service provider to encourage the user to engage with the service provider. An access link 810 may be presented to the user to allow her to engage with the service provider. The sponsored stories section 806 may include advertisements for display to the user.

FIG. 8B illustrates an example notice 814 that may be presented by the social networking system 130 for the user upon selection of the access link 810. The notice 814 may provide more information about the service provider and its offerings for the user. Such information may include a description of the offerings of the service provider, the amount of advertisements that the service provider may display to the user, the computing platforms on which the user may access the offerings, functionality relating to the offerings that are deemed important for the user, payment terms, cancellation terms, etc. An access button 816 may be selected by the user to proceed with engagement with the service provider. A “cancel” button 818 may be selected by the user to cease further consideration of such engagement.

FIG. 8C illustrates an example notice 830 that may be presented by the social networking system 130 for the user upon selection of the access button 816. The notice 830 may include a subscription description 832 that provides information about the features and terms (e.g., price, offering levels, cancellation, refunds, etc.) of the subscription for which the user has opted. A payment method section 834 presents the payment methods associated with the user, and prompts the user to select the particular payment method for the particular offering. An access button 836, when selected, causes a request to be provided to the social networking system 130 to proceed with purchase of the offering. A “cancel” button 838, when selected, allows the user to terminate purchase of the offering.

FIG. 8D illustrates an example notice 850 that may be presented by the social networking system 130 for the user upon selection of the access button 836. The notice 850 may include a confirmation section 852 that indicates to the user that the user has successfully acquired access to the offering of a service provider. The notice 850 may be presented to the user after the social networking system 130 has determined that the payment provided by the user for the offering has been properly processed. The confirmation section 852 also may provide instructions for the user to access the offering, as well as instructions and terms for the user to cancel access to the offering. A “close” button 854, when selected, closes the notice 850.

FIG. 8E illustrates a partial, example user interface 860 of a computing device of the user that may appear after the user has successfully acquired access to the offering of a service provider. As shown, the computing device is a mobile device. The user interface 860 may include a notification icon 862 that, when selected, causes a notifications section 864 to appear in the user interface 860. The notifications section 864 may include a variety of notifications 866, including a notification 868 that informs the user that an application of the service provider is ready to install on the computing device. The application may allow the user to perform any type of function to enable or facilitate access to and consumption of the offerings of the service provider. The notification 868, or a portion thereof, may be a link that is selectable by the user to trigger installation of the application so that the user may access the offering. In an embodiment, the screens shown in FIGS. 5-8 may be tailored for presentation on a desktop, mobile, and any other type of user device.

In an embodiment, information presented to the user, as discussed in connection with FIGS. 5-8, may be maintained by the social networking system 130. Further, when the user requests changes to such information, the information maintained by the social networking system 130 may be appropriately updated to reflect the requested changes. Information about user selection of and eligibility for certain offerings and levels of offerings of service providers also may be maintained by the social networking system 130. The information maintained by the social networking system 130 may be used to manage the offerings made available by service providers to the user through the social networking system 130.

### CONCLUSION

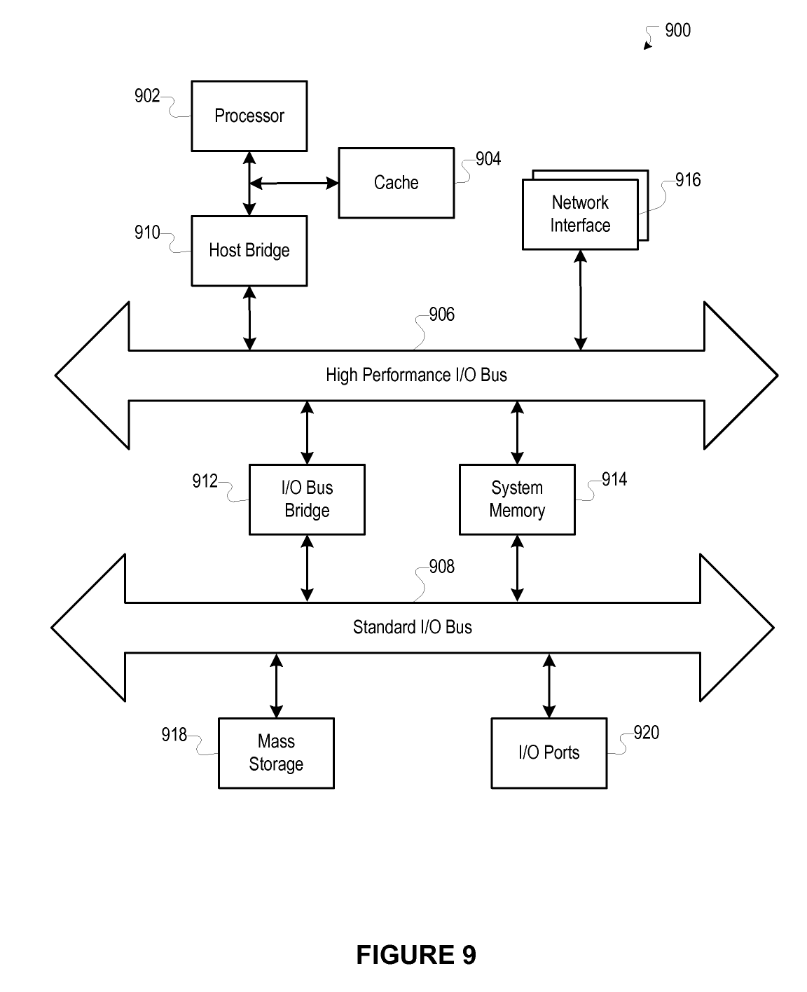

The foregoing processes and features can be implemented by a wide variety of machine and computer system architectures and in a wide variety of network and computing environments. FIG. 9 illustrates an example of a computer system 900 that may be used to implement one or more of the computing devices identified above. The computer system 900 includes sets of instructions for causing the computer system 900 to perform the processes and features discussed herein. The computer system 900 may be connected (e.g., networked) to other machines. In a networked deployment, the computer system 900 may operate in the capacity of a server machine or a client machine in a client-server network environment, or as a peer machine in a peer-to-peer (or distributed) network environment. In an embodiment of the invention, the computer system 900 may be the social networking system 130, the user device 110, the external system 120, or a component thereof. In an embodiment of the invention, the computer system 900 may be one server among many that constitutes all or part of the social networking system 130.

The computer system 900 includes a processor 902, a cache memory 904, and one or more executable modules and drivers, stored on a computer-readable medium, directed to the processes and features described herein. Additionally, the computer system 900 includes a high performance input/output (I/O) bus 906 and a standard I/O bus 908. A host bridge 910 couples the processor 902 to the high performance I/O bus 906, whereas I/O bus bridge 912 couples the two buses 906 and 908 to each other. A system memory 914 and one or more network interfaces 916 couple to the bus 906. The computer system 900 may further include video memory and a display device coupled to the video memory (not shown). Mass storage 918 and I/O ports 920 couple to the bus 908. The computer system 900 may optionally include a keyboard and pointing device, a display device, or other input/output devices (not shown) coupled to the bus 908. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 900, including the input and output of data to and from software applications (not shown). The operating system provides an interface between the software applications being executed on the system and the hardware components of the system. Any suitable operating system may be used, such as the LINUX Operating System; the Apple Macintosh Operating System, available from Apple Computer Inc. of Cupertino, Calif.; UNIX operating systems; Microsoft® Windows® operating systems; BSD operating systems; and the like. Other implementations are possible.

The elements of the computer system 900 are described in greater detail below. In particular, the network interface 916 provides communication between the computer system 900 and any of a wide range of networks, such as an Ethernet (e.g., IEEE 802.3) network, a backplane, etc. The mass storage 918 provides permanent storage for the data and programming instructions to perform the above-described processes and features implemented by the respective computing systems identified above, whereas the system memory 914 (e.g., DRAM) provides temporary storage for the data and programming instructions when executed by the processor 902. The I/O ports 920 may be one or more serial and/or parallel communication ports that provide communication between additional peripheral devices, which may be coupled to the computer system 900.

The computer system 900 may include a variety of system architectures, and various components of the computer system 900 may be rearranged. For example, the cache 904 may be on-chip with processor 902. Alternatively, the cache 904 and the processor 902 may be packed together as a “processor module”, with processor 902 being referred to as the “processor core”. Furthermore, certain embodiments of the invention may neither require nor include all of the above components. For example, peripheral devices coupled to the standard I/O bus 908 may couple to the high performance I/O bus 906. In addition, in some embodiments, only a single bus may exist, with the components of the computer system 900 being coupled to the single bus. Furthermore, the computer system 900 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 900 which, when read and executed by one or more processors, cause the computer system 900 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 900, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 902. Initially, the series of instructions may be stored on a storage device, such as the mass storage 918. However, the series of instructions can be stored on any suitable computer readable storage medium. Furthermore, the series of instructions need not be stored locally, and could be received from a remote storage device, such as a server on a network, via the network interface 916. The instructions are copied from the storage device, such as the mass storage 918, into the system memory 914, and then accessed and executed by processor 902.

Examples of computer readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 900 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “another embodiment”, or the like means that a particular feature, design, structure, or characteristic described in connection with the embodiment is included in at least one embodiment of the disclosure. The appearances of, for example, the phrase “in one embodiment”, “in an embodiment”, or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method comprising:
maintaining, by a computer system, information regarding eligibility of a user to receive an offering of a service provider;
receiving, by the computer system, a request for the information regarding eligibility of the user from the service provider; and
providing, by the computer system, the information regarding eligibility of the user to the service provider.

2. The method of claim 1, wherein the providing is performed before at least a portion of the offering is provided to the user.

3. The method of claim 1, wherein the providing is performed periodically.

4. The method of claim 1, further comprising tracking a level of consumption by the user of the offering.

5. The method of claim 4, further comprising determining that the level of consumption has satisfied a threshold.

6. The method of claim 5, further comprising requesting the user to upgrade an account with the service provider.

7. The method of claim 5, further comprising providing a promotion to the user based on the level of consumption by the user.

8. The method of claim 7, wherein the promotion includes at least one of an email, a story, a badge, and a reference.

9. The method of claim 1, further comprising receiving information about selection by the user of the offering.

10. The method of claim 1, wherein the offering includes a subscription.

11. The method of claim 1, wherein the offering includes charitable services.

12. The method of claim 1, wherein the offering is associated with services not provided to the user for consumption.

13. The method of claim 1, wherein the service provider provides at least one of music, content, and games.

14. The method of claim 1, further comprising receiving payment information of the user for the offering.

15. The method of claim 1, further comprising maintaining payment information of the user for the offering.

16. The method of claim 1, further comprising receiving a requested change regarding terms of a subscription of the user.

17. The method of claim 1, wherein the providing is performed by a social networking system.

18. The method of claim 1, further comprising providing a notification for the user to install an application of the service provider on a mobile computing device.

19. A computer-storage medium storing computer-executable instructions that, when executed, cause a computer system to perform a computer-implemented method comprising:
maintaining information regarding eligibility of a user to receive an offering of a service provider;
receiving a request for the information regarding eligibility of the user from the service provider; and
providing the information regarding eligibility of the user to the service provider.

20. A system comprising:
at least one processor; and
a memory storing instructions configured to instruct the at least one processor to perform:
maintaining information regarding eligibility of a user to receive an offering of a service provider;
receiving a request for the information regarding eligibility of the user from the service provider; and
providing the information regarding eligibility of the user to the service provider.
